(19) United States
(12) Patent Application Publication
(10) Pub. No.: US 2012/0159207 A1
(43) Pub. Date: Jun. 21, 2012

(54) POWER MANAGEMENT DEVICE AND METHOD THEREOF

(76) Inventors: Hsing-Kuo Chao, Hsin-Chu (TW); Yi-Shan Chu, Hsin-Chu (TW)

(21) Appl. No.: 13/326,329

(22) Filed: Dec. 15, 2011

(30) Foreign Application Priority Data
Dec. 16, 2010 (TW) 099144181

(51) Int. Cl. G06F 1/26

(52) U.S. Cl. 713/310

(57) ABSTRACT

A power management device of an SD memory card reader includes a power supply regulator and a controller. The controller controls the power supply regulator to provide a memory card voltage according to an external control signal transmitted from a single control pin. Wherein when the external control signal denotes an enable state, the power supply regulator provides the memory card voltage; when the external control signal denotes a disable state, the power supply regulator stops providing the memory card voltage and discharges the load capacitor; and when the external control signal returns to the enable state from the disable state in a predetermined duration, the power supply regulator changes the memory card voltage.

### BACKGROUND OF THE INVENTION

1. Field of the Invention

The present invention relates to a power management device of an SD (Secure Digital) memory card reader, and more particularly, to a power management device of an SD memory card reader capable of controlling power by a single control pin.

2. Description of the Prior Art

Generally, a user can access data stored in an SD (Secure Digital) memory card by a card reader. SD (Secure Digital) memory card specification 2.0 sets the memory card voltage as 3.3V, while SD memory card specification 3.0 sets the memory card voltage as 1.8V. To be compatible with both SD memory card specifications 3.0 and 2.0, a card reader initially provides a memory card voltage with voltage level at 3.3V to the SD memory card inserted into the card reader, then sends a request to inquire the SD memory card whether it supports the SD memory card specification 3.0. If the SD memory card answers positively, the card reader switches the memory card voltage to 1.8V.

FIG. 1 shows a power management device 100 of an SD memory card reader of the prior art. Power management device 100 is capable of charging a load capacitor 102 for providing the memory card voltage. Power management device 100 comprises a controller 104, a low voltage output circuit 120 and a high voltage output circuit 130. When the SD memory card is initially inserted into the card reader, control pins SDEN1 and SEDN2 receive logic signals 1 and 0 respectively, and switch 131 is turned on, and switch 133 and low voltage output circuit 120 are turned off, such that power input end VIP, electrically connected to a 3.3V voltage source, is electrically shorted to the SD memory card via switch 131 and power output end VCP. When the SD memory card is pulled out of the card reader, control pins SDEN1 and SEDN2 receive logic signals 0 and 1 respectively, and switch 133 is turned on, and switch 131 is turned off, such that power output end VCP is electrically connected to a ground while resistor 132 limits the discharging current. If the SD memory card inserted supports the SD memory card specification 3.0, control pins SDEN1 and SEDN2 receive logic signals 1 and 1 respectively, and low voltage output circuit 120, acting as a low-voltage dropout (LDO), is turned on, and switches 131, 133, 142 are turned off. Low voltage output circuit 120 regulates the voltage at power output end VCP to be 1.8V by controlling the turn-on resistance of transistor 110 according to feedback voltage VFB and reference voltage VREF. Logic signals 0 and 1 at control pins SDEN1 and SEDN2 respectively when the SD memory card is pulled out of the card reader also turn on switch 142 and discharge power output end VCP to the ground end via resistor 142.

Summarizing the above, power management device 100 of the SD memory card reader of the prior art needs two control pins SDEN1 and SEDN2 for receiving external control signals in order to comply with both the SD memory card specifications 2.0 and 3.0. Moreover, two switches 110 and 131, costly power devices, are needed to switch the memory card voltage between voltage levels of 1.8V and 3.3V. Both switches 133 and 142 are for discharging of power output end VCP, redundantly. Therefore, the above arrangement increases the cost of the power management device and the card reader.

### SUMMARY OF THE INVENTION

It is therefore an objective of the claimed invention to provide a power management device of an SD memory card reader capable of controlling power by a single control pin in order to solve the problems of the prior art.

The present invention provides a power management device, which is capable of charging a load capacitor for providing a memory card voltage, comprising an output transistor, a feedback circuit, a selection circuit, and a controller. The output transistor is electrically connected to an input voltage source, and the output transistor has a control end for charging the load capacitor according to a first control signal or a second control signal. The feedback circuit is electrically connected to the load capacitor for generating the first control signal according to the memory card voltage. The selection circuit selects the first control signal or the second control signal to be received by the output transistor according to a switch signal. The controller generates the switch signal according to an external control signal. Wherein when the output transistor receives the first control signal, the memory card voltage is regulated at a relatively-low level, and when the output transistor receives the second control signal, the memory card voltage is regulated at a relatively-high level.

The present invention further provides a power management device, which is capable of charging a load capacitor for providing a memory card voltage, comprising a power input end, a power output end, a power supply regulator, a control pin, and a controller. The power input end is electrically connected to an input voltage source. The power output end is electrically connected to the load capacitor. The power supply regulator is electrically connected between the power input end and the power output end for providing the memory card voltage. The controller is electrically connected between the control pin and the power supply regulator for controlling the memory card voltage according to an external control signal transmitted from the control pin. Wherein when the external control signal denotes an enable state, the power supply regulator provides the memory card voltage; when the external control signal denotes a disable state, the power supply regulator stops providing the memory card voltage, and discharges the load capacitor; and when the external control signal returns to the enable state from the disable state in a predetermined duration, the power supply regulator changes the memory card voltage.

The present invention further provides a method for controlling a memory card voltage according to a control pin of a power management device, wherein the power management device comprises a power supply regulator and a controller, the power supply regulator is electrically connected between a power input end and a power output end for providing the memory card voltage, and the controller is electrically connected between a control pin and the power supply regulator for controlling the memory card voltage according to an external control signal transmitted from the control pin, the method comprises the power supply regulator providing the memory card voltage when the external control signal denotes an enable state; the power supply regulator stopping providing the memory card voltage and discharging the load capacitor when the external control signal denotes a disable state; and the power supply regulator changing the memory card voltage when the external control signal returns to the enable state from the disable state in a predetermined duration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a power management device of an SD memory card reader of the prior art.

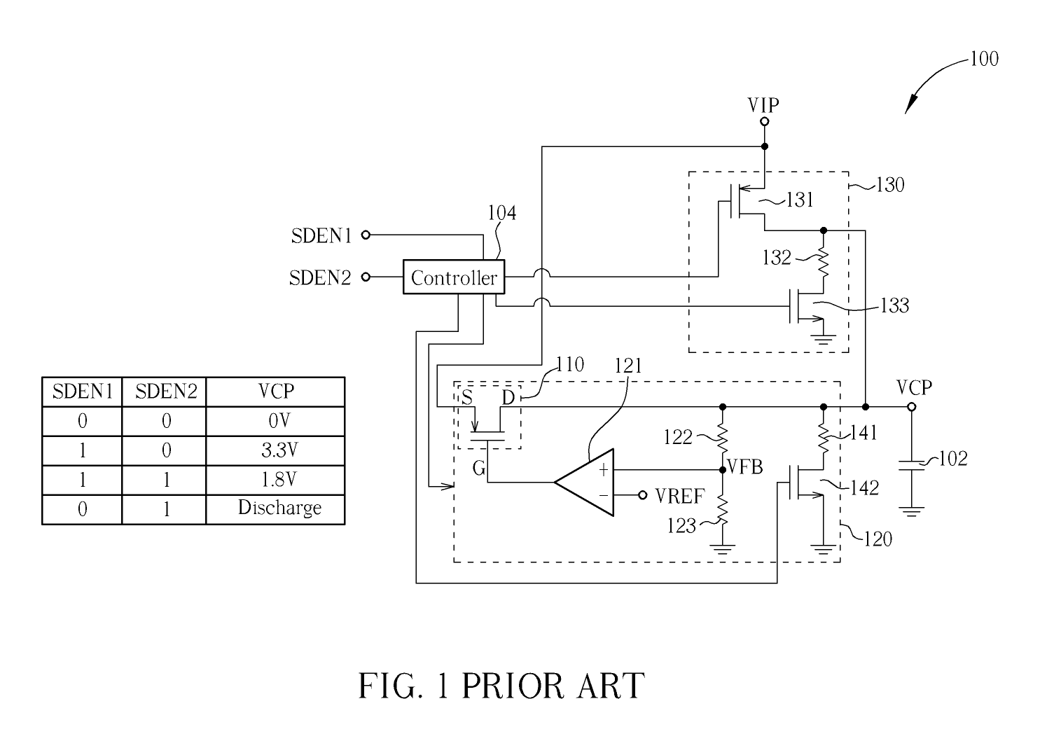

FIG. 2 is a diagram showing a power management device of an SD memory card reader of the present invention.

FIG. 3 is a diagram showing waveforms of signals of the power management device of FIG. 2.

### DETAILED DESCRIPTION

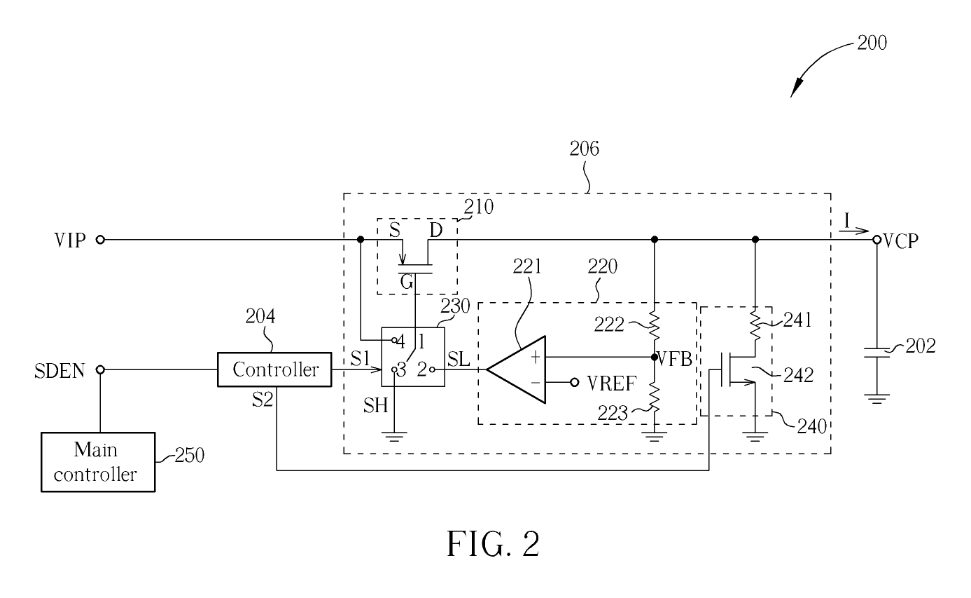

FIG. 2 shows power management device 200 of an SD memory card reader according to an embodiment of the invention. Power management device 200 is capable of charging load capacitor 202 to provide a memory card voltage. Power management device 200 is electrically connected to an input voltage source (of 3.3V) via power input end VIP, and electrically connected to load capacitor 202 via power output end VCP. Power management device 200 comprises power supply regulator 206 and controller 204. Power supply regulator 206 is electrically connected between power input end VIP and power output end VCP, for providing the memory card voltage. Controller 204 is electrically connected between input pin SDEN and power supply regulator 206, for controlling the memory card voltage according to an external control signal transmitted from control pin SDEN. The external control signal is generated by a main controller 250 of the SD memory card reader. The main controller 250 detects whether a memory card is inserted into the SD memory card reader and generates the corresponding external control signal. When the external control signal constantly denotes an enable state, power supply regulator 206 provides the memory card voltage of either 3.3v or 1.8v. When the external control signal constantly denotes a disable state, power supply regulator 206 stops providing the memory card voltage, and discharges load capacitor 202. When the external control signal switches from the enable state to the disable state and soon (within a predetermined duration) back to the enable state, power supply regulator 206 changes the memory card voltage. In other words, when the external control signal is a pulse signal with a predetermined pulse width, the memory card voltage is changed. Therefore, power management device 200 of the present invention needs only one single control pin to comply with both the SD memory card specifications 2.0 and 3.0.

Power supply regulator 206 comprises an output transistor 210, a feedback circuit 220, a selection circuit 230, and a discharge circuit 240. Output transistor 210 is electrically connected to the 3.3V input voltage source via power input end VIP, and output transistor 210 has a control end G for charging load capacitor 202 according to control signal SL or control signal SH. In the present embodiment, output transistor 210 is a PMOS transistor. Control signal SL makes output transistor 210 provide at power output end VCP a memory card voltage of 1.8V, and control signal SH makes output transistor 210 provide a memory card voltage of 3.3V. Feedback circuit 220 is electrically connected to load capacitor 202 for generating control signal SL according to the memory card voltage. Feedback circuit 220 comprises an operational amplifier 221 and resistors 222 and 223. Resistors 222 and 223 form a voltage divider circuit for generating a feedback voltage VFB proportional to the memory card voltage provided at power output end VCP. Operational amplifier 221 generates control signal SL after comparing feedback voltage VFB with a reference voltage VREF to dynamically control charging of load capacitor 202 by output transistor 210 and set the memory card voltage provided at power output end VCP to 1.8V. Selection circuit 230 selects a first control signal SL or a second control signal SH to be received by output transistor 210 according to a switch signal S1. Discharge circuit 240 is electrically connected to load capacitor 202 for discharging load capacitor 202 according to a discharge signal S2 generated by controller 204. Discharge circuit 240 comprises a resistor 241 and a transistor 242. When transistor 242 is turned on, load capacitor 202 is electrically connected to a ground end for discharging via resistor 241.

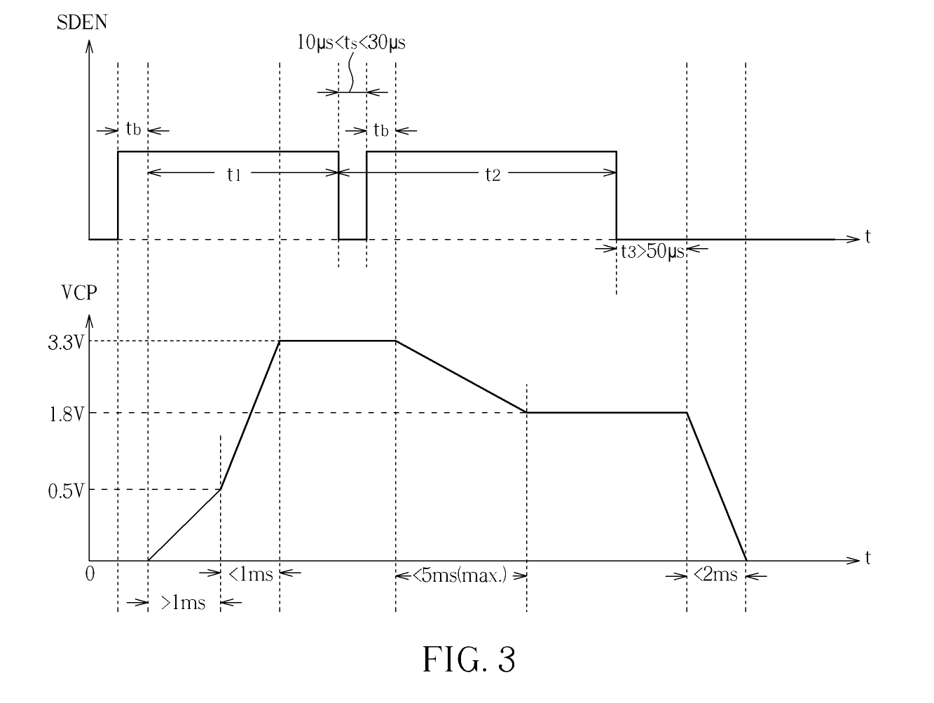

Please refer to FIG. 3, which is a diagram showing waveforms of signals of power management device 200 of FIG. 2. The waveforms of the signals of power management device 200 can be divided into three time sections. Time section t1 represents the waveforms of the signals when the SD memory card is inserted into the card reader. Time section t2 represents the waveforms of the signals when the card reader switches the memory card voltage provided at power output end VCP. Time section t3 represents the waveforms of the signals when the SD memory card is pulled out of the card reader. When the SD memory card is inserted into the card reader, power management device 200 receives from input pin SDEN an external control signal denoting the enable state (at a high logic level), and selection circuit 230 electrically connects the first end 1 to the third end 3 according to switch signal S1 of controller 204. In the meantime, control end G of output transistor 210 is shorted to the ground end, receiving control signal SH from the ground end. Therefore, output transistor 210 is fully turned on and the memory card voltage provided at power output end VCP is pulled to be the same with the voltage at power input end VIP, which is 3.3v in the present embodiment. As shown in FIG. 3, in time section t1, control pin SDEN receives a high logic level signal, and the memory card voltage provided at power output end VCP rises from 0V to 3.3V. The memory card voltage provided at power output end VCP rises slowly from 0V to 0.5V (longer than 1 ms) in the beginning. Such a soft-start function can prevent inrush current in order to protect the memory card. Thereafter, the memory card voltage provided at power output end VCP rises faster from 0.5V to 3.3V (less than 1 ms). The memory card voltage provided at power output end VCP can be expressed as 3.3V−(I*RON), wherein I represents the current, and RON represents the conductive resistor of output transistor 210.

If the SD memory supports the SD memory card specification 3.0, SD memory could positively answers the inquiry from the card reader, which correspondingly generates a pulse to the external control signal. When power management device 200 recognizes from control pin SDEN that, as shown in the beginning of time section t2, the external control signal switches to the disable state (at the low logic level) from the enable state (at the high logic level) and quickly in a predetermined duration returns back to the disable state, switch signal S1 is altered and renders selection circuit 230 to electrically connect the first end 1 to the second end 2, in order to electrically connect control end G of output transistor 210 to feedback circuit 220 for receiving control signal SL from feedback circuit 220. Therefore, the memory card voltage provided at power output end VCP is regulated at a lower level (1.8V). As shown in FIG. 3, in time section t2, the external control signal received by control pin SDEN changes its logic level from high to low and back to high again in the predetermined duration ts. In the present embodiment, predetermined duration ts is between 10 μs and 30 μs. The switch time while the memory card voltage switches from 3.3V to 1.8V after an anti-bouncing time tb is preferably less than 5 ms.

When the card reader senses that the SD memory card is pulled out, it switches the external control signal to remain at a low logic level, denoting the disable state, and selection circuit 230 electrically connects the first end 1 to the fourth end 4 according to switch signal S1 of controller 204, electrically connecting control end G of output transistor 210 to source end S and equivalently shutting down output transistor 210. In addition, controller 204 further asserts discharge signal S2 such that transistor 242 in discharge circuit 240 is turned on to discharge load capacitor 202 to the ground end via resistor 241. As shown in FIG. 3, in time section t3, control pin SDEN continues to receive a low logic level signal. In the present embodiment, if the time during which control pin SDEN continues to receive a low logic level signal is longer than 50 μs, controller 204 treats it as a confirmation of discharging request. Therefore, output transistor 210 is turned off, transistor 242 of discharge circuit 240 is turned on, and the memory card voltage provided at power output end VCP can be discharged to 0 V within the demanded time (less than 2 ms, preferably).

Summarizing the above, the exemplified power management device of the card reader comprises a power supply regulator and a controller. The controller controls the memory card voltage according to the external control signal transmitted from the single control pin. When the external control signal substantially denotes an enable state, the power supply regulator provides the memory card voltage. When the external control signal substantially denotes a disable state, the power supply regulator stops providing the memory card voltage. When the external control signal goes to the disable state and back to the enable state in the predetermined duration, the power supply regulator changes the memory card voltage. Therefore, the power management device of the card reader of the present invention needs only one single control pin to achieve the enable state, discharge the load capacitor, and dynamically control the voltage of the SD memory card, complying with both SD memory card specifications 2.0 and 3.0. The exemplified power management device further possesses the soft-start function and built-in discharge path. Moreover, the present invention simplifies the circuit of the power management device for saving cost and space.

Those skilled in the art will readily observe that numerous modifications and alterations of the device and method may be made while retaining the teachings of the invention.

What is claimed is:

1. A power management device capable of charging a load capacitor and providing a memory card voltage, the power management device comprising:
an output transistor electrically connected to an input voltage source, the output transistor having a control end for charging the load capacitor according to a first control signal or a second control signal;
a feedback circuit electrically connected to the load capacitor for generating the first control signal according to the memory card voltage;
a selection circuit for selecting the first control signal or the second control signal to be received by the output transistor according to a switch signal; and
a controller for generating the switch signal according to an external control signal;
wherein when the output transistor receives the first control signal, the memory card voltage is regulated at a relatively-low level, and when the output transistor receives the second control signal, the memory card voltage is regulated at a relatively-high level.

2. The power management device of claim 1, wherein when the external control signal substantially remains at a high logic level, the selection circuit switches the control end of the output transistor to receive the second control signal, and when the external control signal is an impulse signal with a predetermined pulse width, the selection circuit switches the control end of the output transistor to receive the first control signal.

3. The power management device of claim 1, further comprising a discharge circuit electrically connected to the load capacitor, for discharging the load capacitor according to a discharge signal generated by the controller.

4. The power management device of claim 3, wherein when the external control signal substantially maintains at a low logic level, the controller generates the discharge signal to discharge the load capacitor.

5. The power management device of claim 3, wherein when the discharge circuit discharges the load capacitor according to the discharge signal, the output transistor stops charging the load capacitor.

6. The power management device of claim 1, wherein the feedback circuit comprises:
a voltage divider circuit for generating a feedback voltage proportional to the memory card voltage; and
an operational amplifier for generating the first control signal after comparing the feedback voltage with a reference voltage to dynamically control charging of the load capacitor by the output transistor and set the memory card voltage to the lower level.

7. The power management device of claim 1, wherein the second control signal is provided by a ground end.

8. The power management device of claim 1, wherein the controller receives the external control signal from a control pin.

9. A power management device capable of charging a load capacitor for providing a memory card voltage, the power management device comprising:
a power input end electrically connected to an input voltage source;
a power output end electrically connected to the load capacitor;
a power supply regulator electrically connected between the power input end and the power output end, for providing the memory card voltage;
a control pin; and
a controller electrically connected between the control pin and the power supply regulator, for controlling the memory card voltage according to an external control signal transmitted from the control pin;
wherein when the external control signal denotes an enable state, the power supply regulator provides the memory card voltage;
when the external control signal denotes a disable state, the power supply regulator stops providing the memory card voltage, and discharges the load capacitor; and
when the external control signal returns to the enable state from the disable state in a predetermined duration, the power supply regulator changes the memory card voltage.

10. The power management device of claim 9, wherein the power supply regulator comprises a power switch, and when the external control denotes the enable state, the power switch is switched to provide the input voltage source as the memory card voltage.

11. The power management device of claim 10, wherein the power supply regulator further comprises a feedback circuit, and when the external control signal returns to the enable state from the disable state in the predetermined duration, the power switch is switched to provide the memory card voltage at a lower voltage level according to the feedback circuit.

12. The power management device of claim 10, wherein the power supply regulator further comprises a discharge circuit, and when the external control denotes the disable state, the power switch is switched off, and the discharge circuit discharges the load capacitor.

13. A card reader comprising:
a main controller for detecting whether a memory card is inserted into a memory slot; and
the power management device of claim 9;
wherein when the main controller detects the memory card is inserted into the memory slot, the main controller controls the external control signal to be in the enable state, and the power supply provides the memory card voltage to the memory card at a higher voltage level;
when a response of the memory card corresponds to a certain condition, the main controller makes the external control signal return to the enable state from the disable state in the predetermined duration, and the power supply regulator provides the memory card voltage to the memory card at a lower voltage level; and
when the main controller detects the memory card is not inserted into the memory slot, the main controller controls the external control signal to be in the disable state.

14. A method for controlling a memory card voltage according to a control pin of a power management device, wherein the power management device comprises a power supply regulator and a controller, the power supply regulator is electrically connected between a power input end and a power output end for providing the memory card voltage, and the controller is electrically connected between a control pin and the power supply regulator for controlling the memory card voltage according to an external control signal transmitted from the control pin, the method comprising:
the power supply regulator providing the memory card voltage when the external control signal denotes an enable state;
the power supply regulator stopping providing the memory card voltage and discharging the load capacitor when the external control signal denotes a disable state; and
the power supply regulator changing the memory card voltage when the external control signal returns to the enable state from the disable state in a predetermined duration.

15. The method of claim 14, wherein when the external control signal denotes the enable state, the external control signal is at a high logic level, when the external control signal denotes the disable state, the external control signal is at a low logic level, and when the external control signal returns to the enable state from the disable state in the predetermined duration, the external control signal changes its logic level from high to low and back to high again in the predetermined duration.

16. The method of claim 14, wherein when the external control signal returns to the enable state from the disable state in the predetermined duration, the memory card voltage is changed, the method further comprising:
generating a feedback voltage proportional to the memory card voltage; and
comparing the feedback voltage with a reference voltage for providing the memory voltage at a lower level.

17. The method of claim 16, wherein the memory card voltage is 3.3V at the higher level, and the memory card voltage is 1.8V at the lower level.

18. The method of claim 14 further comprising:
controlling the external control signal to be in the enable state when a memory card is inserted into a card reader;
controlling the external control signal to return to the enable state from the disable state in the predetermined duration when the memory card supports SD (Secure Digital) memory card specification 3.0; and
controlling the external control signal to be in the disable state when the memory card is pulled out of the card reader.
